(19) United States
(12) Patent Application Publication
(10) Pub. No.: US 2014/0321659 A1
(43) Pub. Date: Oct. 30, 2014

(54) SYSTEM FOR INFLUENCING EXHAUST NOISE, ENGINE NOISE AND/OR INTAKE NOISE

(71) Applicant: Eberspächer Exhaust Technology GmbH & Co. KG, Neunkirchen (DE)

(72) Inventors: Federico BUGANZA, Esslingen (DE); Selcuk SERBETCI, Esslingen (DE); Jan KRUEGER, Neuhausen (DE)

(73) Assignee: Eberspächer Exhaust Technology GmbH & Co. KG, Neunkirchen (DE)

(21) Appl. No.: 14/260,541

(22) Filed: Apr. 24, 2014

(30) Foreign Application Priority Data
Apr. 26, 2013 (DE) 10 2013 104 307.0
May 13, 2013 (DE) 10 2013 104 885.4

(51) Int. Cl. G10K 11/00

(52) U.S. Cl. CPC G10K 11/002
USPC 381/71.4

(57) ABSTRACT

A system (7), for influencing noises of a vehicle, includes a controller (9) and at least one connected loudspeaker (2) that generates noise inside a sound generator (3) in response to a control signal. The controller includes a microprocessor (91; 91′), a digital-to-analog converter (92), an amplifier (93), and a step-up converter (97). The microprocessor generates a digital control signal, to generate a noise to cancel noise inside an exhaust system and/or an intake system and/or to generate a noise inside an engine compartment. The digital control signal is converted by the digital-to-analog converter into an analog control signal. The amplifier amplifies the analog control signal output from the digital-to-analog converter. The step-up converter is connected to an automobile battery (10) of the vehicle and converts a battery voltage (VBATT) supplied by the automobile battery to a constant value, with this output as a supply voltage (VB) to the amplifier.

### CROSS REFERENCE TO RELATED APPLICATIONS

This application claims the benefit of priority under 35 U.S.C. §119 of German Patent Applications DE 10 2013 104 307.0 filed Apr. 26, 2013 and DE 10 2013 104 885.4 filed May 13, 2013, the entire contents of which are incorporated herein by reference.

### FIELD OF THE INVENTION

The invention relates to a system for influencing sound waves propagating in exhaust systems of vehicles driven by internal combustion engines (exhaust noises) and/or for influencing engine noise generated by an engine in the engine compartment of a vehicle and/or for influencing sound waves propagating in intake systems of internal combustion engines (intake noises).

### BACKGROUND OF THE INVENTION

Regardless of the type of an internal combustion engine (for example reciprocating engine, pistonless rotary engine or free-piston engine), noises are generated as a result of the successively executed strokes (in particular intake and compression of the fuel-air mixture, combustion and discharge of the combusted fuel-air mixture). On the one hand, the noises propagate through the internal combustion engine in the form of solid-borne sound and are emitted to the outside of the internal combustion engine in the form of airborne sound. On the other hand, the noises propagate in the form of airborne sound together with the combusted fuel-air mixture through an exhaust system that is in fluid communication with the internal combustion engine.

These noises are often regarded as being disadvantageous. On the one hand, there are statutory provisions on protection against noise to be observed by manufacturers of vehicles driven by internal combustion engines. These statutory provisions normally specify a maximum sound pressure for an operation of a vehicle. Manufacturers, on the other hand, try to impart a characteristic noise emission to internal combustion engine driven vehicles of their production, with the noise emission fitting the image of the respective manufacturer and being popular with customers. Present-day engines with small displacement often cannot naturally generate such intended characteristic noise.

The noises propagating through the internal combustion engine in the form of solid-borne sound can be muffled quite well and are thus usually not a problem as far as protection against noise is concerned. With the increasing use of internal combustion engines having small displacements or even of electric motors, the problem arises that the engine (or motor) noise is often not attractive for users and/or does not fit the image of a vehicle manufacturer.

Due to the engine noise being nearly completely missing with the use of electro motors, there is also the problem that pedestrians often fail to notice electric vehicles or notice them too late. In order to resolve this problem, it is suggested to dispose a loudspeaker inside the engine (motor) bay for tuning or generating the desired engine noise.

The noises traveling together with the combusted fuel-air mixture in the form of airborne sound through the exhaust system of the internal combustion engine are reduced by exhaust silencers (also known as mufflers) located ahead of the exhaust system's discharge opening and downstream of catalytic converters if present. Respective silencers may for instance work according to the absorption and/or reflection principle. The disadvantage of both operating principles is that they require a comparatively large volume and create a comparatively high resistance to the combusted fuel-air mixture resulting in a drop of the vehicle's overall efficiency and an increased fuel consumption.

For quite some time, so-called anti-noise systems have been developed as an alternative or supplement to silencers, which superimpose electro-acoustically generated anti-noise on airborne noise generated by the internal combustion engine and propagated through the exhaust system. Respective systems are for instance known from the following documents: U.S. Pat. No. 4,177,874, U.S. Pat. No. 5,229,556, U.S. Pat. No. 5,233,137, U.S. Pat. No. 5,343,533, U.S. Pat. No. 5,336,856, U.S. Pat. No. 5,432,857, U.S. Pat. No. 5,600,106, U.S. Pat. No. 5,619,020, EP 0 373 188, EP 0 674 097, EP 0 755 045, EP 0 916 817, EP 1 055 804, EP 1 627 996, DE 197 51 596, DE 10 2006 042 224, DE 10 2008 018 085 and DE 10 2009 031 848.

Respective anti-noise systems typically use a so-called Filtered-X, Least Mean Squares (FxLMS) algorithm trying to turn an error signal measured with an error microphone by outputting acoustic noise with at least one loudspeaker being in fluid communication with the exhaust system down to zero (in the case of noise-cancellation) or to a preset threshold (in the case of influencing noise). For achieving a completely destructive interference between the sound waves propagating through the exhaust system and the anti-noise generated by the loudspeaker, the sound waves originating from the loudspeaker have to match the sound waves propagating through the exhaust system in amplitude and frequency, however, with a relative phase shift of 180 degrees. If the anti-noise sound waves generated at the loudspeaker match the sound waves propagating through the exhaust system in frequency and have a phase shift of 180 degrees relative thereto, but do not match the sound waves in amplitude, only an attenuation of the sound waves propagating through the exhaust system results. The anti-noise is calculated separately for each frequency band of the airborne noise propagating through the exhaust pipe using the FxLMS-algorithm by determining a proper frequency and phasing of two sine oscillations being shifted with respect to each other by 90 degrees, and by calculating the required amplitudes for these sine oscillations. The objective of anti-noise systems is that the cancellation or influencing of sound at least outside of, but, as the case may be, also inside the exhaust system, is audible and measurable. The term “anti-noise” used in this document serves the distinction for airborne sound caused by both turbulences in the flow of exhaust gas and the internal combustion engine itself and propagated in the exhaust system. In itself, anti-noise is just plain airborne sound. It is pointed out that the present document is not limited to a use of an FxLMS algorithm.

Also, in intake systems of internal combustion engines sound waves occur, which may be regarded as annoying. These sound waves are caused by both turbulences in the flow of air and the internal combustion engine itself. The intake system, also called induction tract, includes all air guiding components of an internal combustion engine located ahead of the combustion chamber or combustion space.

### SUMMARY OF THE INVENTION

It is a disadvantage of already known systems for influencing exhaust noise and/or intake noise and/or engine noise that the reliability of the noise cancellation and the influenced of the noise, respectively, is insufficient. Furthermore, known systems have an insufficient efficiency.

Embodiments according to the invention provide a system for influencing exhaust noises and/or intake noises and/or engine noises exhibiting an improved reliability of the noise generation, and at the same time a higher efficiency due to smaller losses.

Embodiments, according to the invention, of a system for influencing exhaust noises and/or intake noises and/or engine noises of vehicles, and in particular of vehicles driven by internal combustion engines, comprise a controller, and in particular an anti-noise controller, and at least one loudspeaker, with the loudspeaker being connected to the controller for receiving control signals. The connection may, for instance, be implemented electrically or optically.

The at least one loudspeaker is configured to generate sound, and in particular anti-noise, within an associated sound generator in response to a control signal received from the controller. The sound generator protects the loudspeaker from contamination and/or influence of weather and/or thermal stress. Thus, in some embodiments the sound generator can be considered to be a casing of the loudspeaker. The sound generator also acts as a sound guide as it may be configured for being connected in fluid communication with an intake system, an exhaust system, and engine compartment and a passenger compartment.

The sound generator may be configured for being disposed within a vehicle's engine compartment. Alternatively, the loudspeaker may be disposed directly within the engine compartment or exhaust system without a sound generator (without a housing or sound guide/connecting channel).

The sound generator may alternatively or additionally be configured for being connected in fluid communication to the exhaust system. An exchange of fluid (liquid or gas) present in an interior of the sound generator and in an interior of the exhaust system is thus possible. It is not required that there be an exchange of the whole of the fluid present in the sound generator with that present in the interior of the exhaust system. The interior of the sound generator may, for instance be divided in two sections by a membrane of the loudspeaker. The indirect integration of the loudspeaker into the exhaust system using a sound generator reduces the mechanical and thermal stress of the loudspeaker caused by the exhaust gases flowing through the exhaust system.

The sound generator may alternatively or additionally be configured for being connected in fluid communication to the intake system.

The controller comprises at least one microprocessor, at least one digital-to-analog converter, at least one amplifier, and at least one and especially exactly one step-up converter. The amplifier may in particular be an analog amplifier, and further in particular an audio amplifier.

The at least one microprocessor is configured to generate a digital control signal adapted to at least partially, and in particular completely, silence noise inside the exhaust system or the intake system in amplitude and phase when the at least one loudspeaker is in fluid communication with the exhaust system or the intake system, respectively, and is operated based on such a digital control signal. The microprocessor is alternatively or additionally configured to generate a digital control signal adapted to generate a noise, and in particular an engine noise, inside the engine bay, when the at least one loudspeaker is located inside the engine bay and operated based on such a digital control signal.

The at least one microprocessor may be an individual device or may be integrated into another control unit of the vehicle, and in particular into an engine control unit for the internal combustion engine of the vehicle.

The at least one digital-to-analog converter is electrically connected to the at least one microprocessor and configured to convert the digital control signal output from the at least one microprocessor into an analog control signal. The connection may for instance be implemented electrically or optically. The at least one digital-to-analog converter may be an individual device or may be integrated into the at least one microprocessor.

The at least one amplifier is electrically connected to the at least one digital-to-analog converter and configured to amplify the analog control signal output from the at least one digital-to-analog converter such that the at least one loudspeaker can be operated with the amplified analog control signal. The amplifier may in particular be a class AB amplifier, full bridge amplifier, class D amplifier or class G/H amplifier. Full bridge amplifiers and amplifiers of class AB, G/H are distinguished by their increased electromagnetic compatibility, amplifiers of class D by a high efficiency.

The step-up converter is configured for being connected to an automobile battery of a vehicle and adapted to up-convert the battery voltage supplied by the automobile battery to a constant value and to output the up-converted battery voltage as supply voltage to the at least one amplifier. For this purpose, the step-up converter is electrically connected to the at least one amplifier. According to the invention, a DC-DC converter, also known as boost converter or step-up chopper, where the value of the output voltage is always higher or equal to the value of the input voltage, is generally understood as step-up converter. The “constant value” of the voltage output from the step-up converter hereby means a voltage which value varies not more than 5%, and in particular not more than 3% with respect to the value set for the voltage.

Using the boost converter ensures that a constant supply voltage is available for the at least one amplifier and thus effects a decoupling from the voltage of the automobile battery usually varying between 9 V and 16 V. Consequently, the at least one loudspeaker of the system may reliable be operated with an ideal control signal. The improved reliability even at varying voltage of the automobile battery is particularly important when using the system for conforming to statutory provisions concerning the noise level of the airborne noise traveling through the exhaust system.

Using the step-up converter further allows a utilization of amplifiers requiring a supply voltage that is higher than the vehicle's battery voltage. Respective amplifiers enable an increase in the voltage level of the amplified analog control signal as compared to amplifiers being supplied with the voltage from the automobile battery. As a result of this, loudspeaker with a higher input impedance may be used, whereby the resistive losses on the line between the at least one amplifier and the at least one loudspeaker are for the same power level lower, due to the higher voltage and the lower currents of the amplified analog control signal. The lower currents further increase the electromagnetic compatibility. Respective amplifiers further enable an increase of the ratio between the peak value and the root-mean-square value of the amplified analog control signal and thus of the crest factor, due to the building up of power reserves.

According to an embodiment, the step-up converter is configured for converting the battery voltage from the automobile battery to a constant value that can be preset to between 12 V and 48 V, and in particular to 12 V or 16 V or 24 V or 32 V or 36 V or 42 V or 48 V, and for supplying this voltage to the at least one amplifier in the form of a supply voltage. This is considerably higher than the voltage level of supply voltages of amplifiers of conventional systems, and in particular conventional anti-noise systems. Due to the higher voltage level, loudspeakers with higher impedances can be used with the same power requirements, resulting in lower supply currents. Line losses are hereby reduced or smaller wire cross section may be used, reducing the system costs. On the whole, the efficiency of system is hereby increased. Further, the electromagnetic compatibility is improved.

According to an embodiment, the controller is an anti-noise controller configured for being connected with the engine control unit of an engine, and in particular of an internal combustion engine of the vehicle. The at least one microprocessor of the controller is furthermore adapted to generate the digital control signal depending on signals received from the engine control unit. In this way, the operating conditions of the engine can be allowed for in the calculation of the control signal performed by the microprocessor.

According to an embodiment, the system is an anti-noise system and further comprises an error microphone connected to the controller and configured for being disposed, with respect to the exhaust gas flow, at a position of the exhaust system located in the region of the fluid connection between the sound generator and the exhaust system. “Disposed at a position in the region of the fluid connection between the sound generator and the exhaust system” hereby means that the position at which the fluid connection is effected and the noise is at least partially silenced is, with respect to the exhaust gas flow, spaced apart from the error microphone upstream along the exhaust gas flow by not more than the tenfold, and in particular by not more than the fivefold, and further in particular by not more than twice the maximum diameter of the exhaust system at the position where the noise is measured by the error microphone. The error microphone is configured to measure noise inside the exhaust system and to output a corresponding measurement signal to the controller. The at least one microprocessor of the controller is configured to annihilate signals received from the error microphone at least in part and preferably completely in amplitude and phase by outputting the control signal to the at least one loudspeaker. It is, however, pointed out, that the present invention is not limited to anti-noise systems.

According to an embodiment, the system is an anti-noise system and further comprises an error microphone connected to the controller and configured for being disposed at a position of the intake system located, with respect to the flow of drawn in air, in the region of the fluid connection between the sound generator and the intake system. “Disposed at a position of the intake system in the region of the fluid connection between the sound generator and the intake system” hereby means that the position at which the fluid connection is effected and the noise is at least partially silenced is, with respect to the intake air flow, spaced apart from the error microphone downstream along the flow of drawn in air by not more than the tenfold, and in particular by not more than the fivefold, and further in particular by not more than twice the maximum diameter of the intake system at the position where the error microphone is located and the noise is measured. The error microphone is configured to measure noise inside the intake system and to output a corresponding measurement signal to the controller. The at least one microprocessor of the controller is configured to annihilate signals received from the error microphone at least in part and preferably completely in amplitude and phase by outputting a control signal to the at least one loudspeaker. It is, however, pointed out, that the present invention is not limited to anti-noise systems.

The terms “upstream” and “downstream” are hereby to be understood as follows: a first portion of a flow path is located upstream of a second portion of the same flow path, the second portion being different to the first portion, when a medium flowing in a constant direction along the flow path passes the first portion first and the second portion thereafter. With respect to the same medium flowing in a constant direction along the flow path, the second portion is then simultaneously located downstream of the first portion.

According to an embodiment, the at least one digital-to-analog converter is integrated into the at least one microprocessor, and, where appropriate, also into the engine control unit of the vehicle. By this, the number of components is kept low.

According to an embodiment a filter, and in particular a voltage smoothing circuit, is disposed between the automobile battery and the step-up converter. This allows to reduce malfunctions.

According to an embodiment, the at least one loudspeaker has an input impedance of between 2Ω and 12Ω, and in particular between 3Ω and 4Ω. Said input impedance is significantly higher than that of loudspeakers of conventional systems, and in particular of conventional anti-noise systems.

According to an embodiment, the amplifier is a class D amplifier and a LC low pass is disposed between the at least one amplifier and the at least one loudspeaker. According to an embodiment, a module for increasing the electromagnetic compatibility is further disposed between the at least one amplifier and the at least one loudspeaker.

Embodiments of a motor vehicle comprise an internal combustion engine with an engine control unit, an intake system, and an exhaust system respectively being in fluid communication with the internal combustion engine, an automobile battery, and the above system. The at least one sound generator of the system is hereby in fluid communication with at least one of the intake system and the exhaust system. Further, the controller of the system is an anti-noise controller electrically connected with the engine control unit of the internal combustion engine of the vehicle.

According to an embodiment, the anti-noise-controller comprises an error microphone disposed at a position of the intake system located with respect to the flow of the drawn in air in a region of the fluid connection between the sound generator and the intake system and being connected to the intake system. The error microphone may alternatively or additionally be disposed at a position of the exhaust system located with respect to the flow of the exhaust gases in a region of the fluid connection between the sound generator and the exhaust system and being connected to the exhaust system. Further, the anti-noise controller is connected, and in particular electrically connected to the error microphone.

Alternative embodiments of a motor vehicle comprise a driving engine or motor disposed in an engine compartment having an engine control, an automobile battery, and the above system. The driving engine or motor may be an internal combustion engine or an electric motor. The at least one sound generator of the system is hereby in fluid communication with the engine compartment, or the at least one sound generator is disposed in the engine compartment.

Furthermore, the controller of the system is connected, and in particular electrically connected, to the engine control unit of the driving engine or motor.

It should be noted in this context that the term “control”, if not explicitly stated otherwise, is used herein throughout the whole document and different to the German linguistic usage synonymously to the term “closed-loop control”. This applies also to all grammatical modifications of the two terms. The term “controller” may in this document therefore just as well include a feedback of a control variable or its measurement value, respectively, as the term “feedback controller” may refer to a simple control chain.

Further it is noted that the terms “including”, “comprising”, “containing”, “having” and “with”, as well as grammatical modifications thereof used in this specification or the claims for listing features, are generally to be considered to specify a non-exhaustive listing of features like for instance method steps, components, ranges, dimensions or the like, and do by no means preclude the presence or addition of one or more other features or groups of other or additional features.

Further features of the invention will be apparent from the following description of exemplary embodiments together with the claims and the Figures. In the Figures, like or similar reference elements are indicated by like or similar reference signs. It is noted that the invention is not limited to the embodiments of the exemplary embodiments described, but is defined by the scope of the enclosed claims. In particular, embodiments according to the invention may implement individual features in a different number and combination than the examples provided below. In the following explanation of exemplary embodiments of the invention, reference is made to the enclosed Figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a schematic representation of a perspective view of an anti-noise system for an emission control system;

FIG. 2 is a schematic representation showing a block diagram of an anti-noise system in cooperation with an intake system and an exhaust system of an internal combustion engine, whereby the system from FIG. 1 may be used for the exhaust system;

FIG. 3 is a schematic representation showing a block diagram of a controller of a system according to an embodiment of the invention, that may be used in the anti-noise system of FIGS. 1 and 2;

FIG. 4 is a schematic representation showing a block diagram of a controller according to an alternative embodiment of the invention using a system for influencing engine noises inside an engine compartment as example; and

FIG. 5 is a schematic representation showing a motor vehicle having the system according to the invention integrated therein.

### DESCRIPTION OF THE PREFERRED EMBODIMENTS

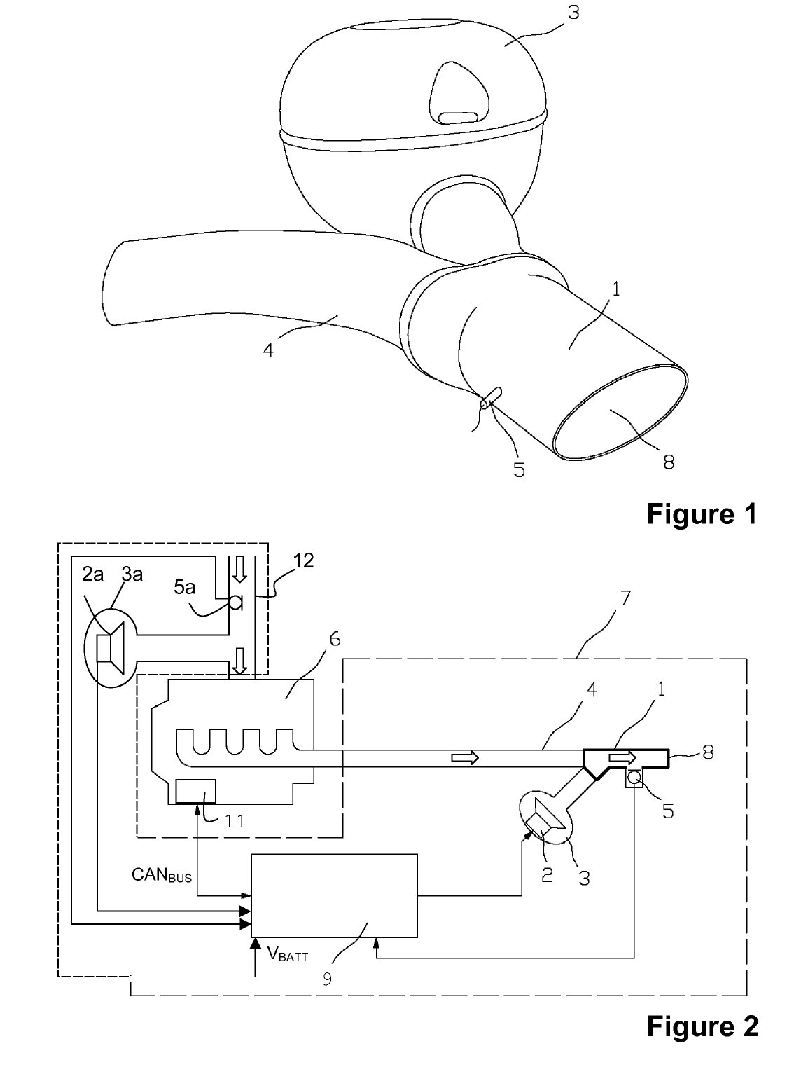

Referring to the drawings in particular, in the following, a system 7 according to an embodiment of the invention is described with reference to FIGS. 1, 2, and 3, and by taking the example of an anti-noise system.

The anti-noise system 7 comprises a sound generator 3 in the form of a soundproofed housing containing a loudspeaker 2 being connected to the exhaust system 4 in the region of a tail pipe 1.

The tailpipe 1 includes a discharge opening 8 for discharging exhaust gases 4 flowing through the exhaust system.

An error microphone 5 in the form of a pressure sensor is provided at the tailpipe 1. The error microphone 5 measures the pressure variations and thus the noise inside the tailpipe 1 in a section downstream of a region providing the fluid connection between the exhaust system 4 and the sound generator 3.

It is, however, pointed out that the present invention is not limited to such an arrangement of the error microphone. In general it is sufficient to have the error microphone spaced apart downstream along the exhaust flow from the fluid connection between the sound generator and the exhaust system with respect to the exhaust flow by not more than the tenfold, and in particular by not more than the fivefold, and further in particular by not more than twice the maximum diameter of the exhaust system at this fluid connection. Further, it is pointed out that the error microphone 5 is only optional. Hence, the error microphone is not required when the noise is generated or is to be influenced within the engine or passenger compartment.

A sound generator 3a having a loudspeaker 2a and being comparable to the sound generator 3 shown in FIG. 1 is connected to an intake system 12. An error microphone 5a is disposed in the intake system 12 upstream of the drawn in air.

The flow directions of the drawn in air and of the emission gases are indicated by arrows in FIG. 2.

The loudspeakers 2, 2a and the error microphones 5, 5a are electrically connected to an (anti-noise) controller 9. Further, the controller 9 is connected to an engine control unit 11 of an internal combustion engine 6 via a CAN data bus, and is supplied by an automobile battery 10 with a DC voltage varying between 9 V and 16 V. It is noted that instead of the CAN data bus a different vehicle data bus may be used, in particular a LIN bus, a MOST bus, or a Flexray bus.

The exhaust system 4 may further comprise at least one catalytic converter (not shown) located between the internal combustion engine 6 and the tailpipe 1 for cleaning the exhaust gases emitted from the internal combustion engine 5 flowing through the exhaust system 4.

The general mode of operation of the above system 7 is as follows:

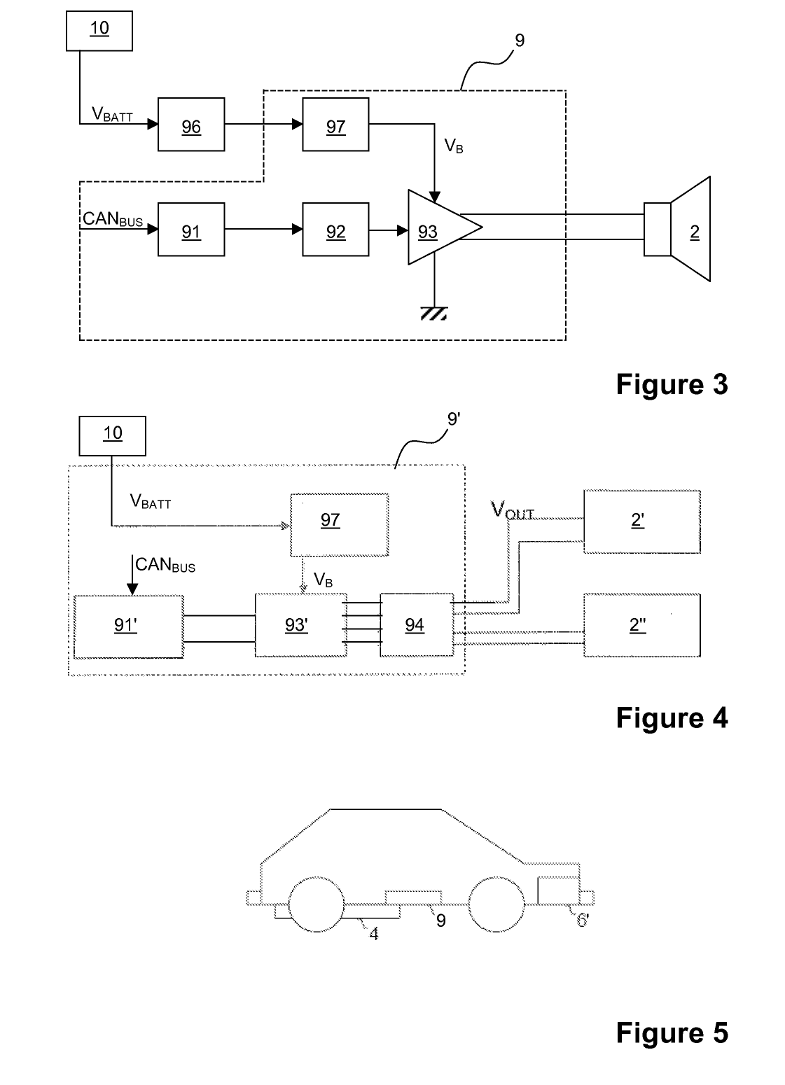

A microprocessor 91, 91′ as shown in FIG. 3 of the anti-noise controller 9 calculates, based on the noises measured with the respective error microphones 5, 5a and based on the operation parameters of the combustion engine 6 received via the CAN data bus, for each of the two loudspeakers 2, 2a a digital control signal using a Filtered-x Least Means Squares (FxLMS) algorithm, whereby the digital control signals enable a substantial silencing of the noise propagating through the interiors of the intake system 12 or the exhaust system by application of anti-noise and are provided to the respective loudspeakers 2, 2a.

FIG. 3 shows a first embodiment of an (anti-noise) controller used in the anti-noise systems shown in FIGS. 1 and 2. For the sake of clarity, FIG. 3 only shows the portion relating to the loudspeaker 2 associated with the exhaust system.

According to the first embodiment shown in FIG. 3, the controller 9 comprises further to the microprocessor 91 a digital-to-analog converter 92 which is connected to the microprocessor 91, converts the digital control signal output from the microprocessor 91 into an analog control signal, and supplies the analog control signal to a class A amplifier 93. The class A amplifier 93 raises the analog signal received from the digital-to-analog converter 92 to a level which enables an operation of loudspeaker 2, and outputs the amplified analog control signal to loudspeaker 2. It is pointed out that the use of filter 94 between the class A amplifier 93 and loudspeaker 2 is only optional. Furthermore, other types of analog amplifiers, and in particular audio amplifiers, may be used.

The supply voltage VB of the class A amplifier 93 is hold available to the latter by a step-up converter 97 being supplied via a filter 96 with a battery voltage VBATT from an automobile battery 10. In the present embodiment, the step-up converter 97 up-converts the battery voltage VBATT supplied to it, which may vary between 9 V and 16 V, into a supply voltage VB for the class A amplifier, the supply voltage being a voltage of constant 24 V, independent from the varying input voltage. As a result, also the amplified analog control signal output from the class A amplifier 93 to the loudspeaker 2 is with respect to its level independent from the varying battery voltage. This is of importance when a noise level of the noise emitted from the exhaust system 4 using the controller as shown in an anti-noise system must not be exceeded in any of the operating conditions due to statutory provisions.

Furthermore, the class A amplifier 93 is, owing its relative to the battery voltage VBATT higher supply voltage VB, able to supply loudspeaker 2 with an amplified analog control signal having a higher voltage level than conventional controllers. On the one hand, this enables a use of a high-impedance loudspeaker 2 having a higher input impedance when compared to conventional anti-noise systems, and on the other hand, the line losses in the supply lines for the loudspeaker 2 are reduced due to the higher voltage levels. Furthermore, the associated lower currents on the supply lines for loudspeaker 2 result in altogether lower electromagnetic interferences improving the electromagnetic compatibility (EMC) of the anti-noise system 7. Finally, when compared to conventional anti-noise controllers, higher supply voltage VB of the class A amplifier 93 enables the implementation of a higher crest factor, and thus the implementation of a higher ratio between peak value and root-mean-square value of the amplified analog control signal output to loudspeaker 2. The reason for this are the power reserves feasible with the higher operation voltage.

Since the second embodiment shown in FIG. 4 is very similar to the first embodiment described above with reference to FIG. 3, in the following, only the differences are addressed and apart from that it is referred to the first embodiment.

Different to the above first embodiment, the controller 9′ according to the second embodiment shown in FIG. 4 is not used in an anti-noise system, but instead used for generating noise with a loudspeaker connected to the controller and disposed within the engine compartment 6′ of a vehicle.

The second embodiment differs from the first embodiment further in that the microprocessor 91′ comprises an integrated digital-to-analog converter, so that it is not necessary to use a separate digital-to-analog converter between microprocessor 91′ and amplifier 93′. Further, a class D amplifier 93′ is used.

In addition, the step-up converter 97 is according to the second embodiment directly connected to the automobile battery 10 so that no filter is provided between the automobile battery and the step-up controller.

Further, a LC low pass 94 is according to the second embodiment disposed at the output of the class D amplifier 93′, with a module for improving the electromagnetic compatibility being integrated into the LC low pass 94.

Finally, two loudspeakers 2′, 2″ are provided according to the second embodiment within the engine compartment 6′ of the vehicle, with the loudspeakers being supplied with the amplified analog control signal from the class D amplifier via the LC low pass 94. Accordingly, the microprocessor 91′ is configured to generate a digital control signal adapted to generate an engine noise inside the engine compartment 6′ when operating the two loudspeakers 2′, 2″ with the control signal.

The schematic representation of FIG. 5 shows a motor vehicle having an engine compartment 6′ housing the internal combustion engine 6, an exhaust system 4, and the above controller 9, 9′. The sound generator and the loudspeaker of the system are not expressly shown in FIG. 5. If the vehicle has an electric motor housed in the motor compartment 6′, the exhaust system 4 is not required.

For the sake of clarity, only those elements, components and functions beneficial for an understanding of the present invention are shown in the Figures. Embodiments of the invention are, however, not limited to the elements, components, and functions shown, but may contain further elements, components, and functions when necessary for their use or their range of functions.

Although the invention has been described above with reference to a maximum of two loudspeakers and accordingly to a maximum of two exhaust systems, the present invention is not limited thereto. In fact, the present invention may be extended to any number of loudspeakers and exhaust systems. Although the present invention has been described with reference to anti-noise systems associated to both the exhaust system and the intake system, the present invention is not limited thereto. Accordingly, one of these anti-noise systems or even both can be omitted.

Although the first embodiment of the controller has been described above with reference to an anti-noise system and the second embodiment with reference to a system for generating engine noises within an engine compartment, the present invention is not limited thereto. The controller of the second embodiment may for example be used in an anti-noise system and the controller of the first embodiment may be used in a system for generating engine noises inside an engine compartment. Further, at least one anti-noise system and a system for generating engine noises with an engine compartment may be used simultaneously.

While specific embodiments of the invention have been shown and described in detail to illustrate the application of the principles of the invention, it will be understood that the invention may be embodied otherwise without departing from such principles.

What is claimed is:

1. A system for influencing at least one of exhaust gas noises and intake noises and engine noises of a vehicle, the system comprising:
a controller; and
at least one loudspeaker connected to the controller for receiving a control signal, with the at least one loudspeaker configured for generating a noise in response to the control signal received from the controller, wherein the controller comprises:
at least one microprocessor configured for generating a digital control signal, with the digital control signal being adapted to at least one of cancel noise inside an intake system of the vehicle at least partially, and cancel noise inside an exhaust system of the vehicle at least partially, and generate an engine noise inside an engine compartment;
at least one digital-to-analog converter connected to the at least one microprocessor and being adapted to convert the digital control signal generated by the at least one microprocessor into an analog control signal;
at least one amplifier connected to the at least one digital-to-analog converter and being adapted to amplify the analog control signal; and
a step-up converter configured for being connected to an automobile battery of the vehicle and being adapted to up-convert a battery voltage supplied by the automobile battery to a higher, constant voltage value, and to output the up-converted battery voltage as a supply voltage to the at least one amplifier.

2. The system according to claim 1, wherein the step-up converter is configured to output the supply voltage that can be preset to between 12 V and 48 V.

3. The system according to claim 1, wherein:
the controller is configured to be connected with an engine control unit of a driving engine of the vehicle; and
the at least one microprocessor of the controller is configured to generate the digital control signal in response to signals received by the engine control unit.

4. The system according to claim 1, further comprising:
a sound generator, the loudspeaker being configured for generating the noise inside the sound generator, wherein the sound generator is configured for being connected in fluid communication with the intake system; and
an error microphone connected to the controller and being configured for being disposed at a position of the intake system located, with respect to the flow of drawn in air, in the region of the fluid connection between the sound generator and the intake system, wherein the error microphone is configured to measure noise inside the intake system, and to output a corresponding measurement signal to the controller, and wherein the at least one microprocessor of the controller is configured to at least partially cancel noise corresponding to signals received from the error microphone by outputting the control signal to the at least one loudspeaker.

5. The system according to claim 1, wherein the at least one digital-to-analog converter is integrated into the at least one microprocessor.

6. The system according to claim 1, wherein a filter comprising a voltage smoothing circuit is disposed between the automobile battery and the step-up converter.

7. The system according to claim 1, wherein the at least one loudspeaker has an input impedance of between 2Ω and 12 Ω.

8. The system according to claim 1, wherein:
the at least one amplifier is a class D amplifier; and
a LC low pass is disposed between the at least one amplifier and the at least one loudspeaker.

9. The system according to claim 1, further comprising:
a sound generator, the loudspeaker being configured for generating the noise inside the sound generator, wherein the sound generator is configured for being connected in fluid communication with the exhaust system; and
an error microphone connected to the controller and being configured for being disposed at a position of the exhaust system located, with respect to the exhaust gas flow, in a region of the fluid connection between the sound generator and the exhaust system, wherein the error microphone is configured to measure noise inside the exhaust system, and to output a corresponding measurement signal to the controller, and wherein the at least one microprocessor of the controller is configured to at least partially cancel noise corresponding to signals received from the error microphone by outputting the control signal to the at least one loudspeaker.

10. The system according to claim 1, wherein:
the step-up converter is configured to up-convert the battery voltage supplied from the automobile battery to a constant value that can be preset to at least one of 32 V, 36 V, 42 V and 48 V, as the supply voltage to the at least one amplifier;
a filter with a voltage smoothing circuit, is disposed between the automobile battery and the step-up converter;
the at least one loudspeaker has an input impedance of between 35Ω and 4Ω;
the at least one amplifier is a class D amplifier; and
a LC low pass is disposed between the at least one amplifier and the at least one loudspeaker.

11. The system according to claim 4, further comprising:
a sound generator, the loudspeaker being configured for generating the noise inside the sound generator, wherein the sound generator is configured for being connected in fluid communication with the exhaust system; and
an error microphone connected to the controller and being configured for being disposed at a position of the exhaust system located, with respect to the exhaust gas flow, in a region of the fluid connection between the sound generator and the exhaust system, wherein the error microphone is configured to measure noise inside the exhaust system, and to output a corresponding measurement signal to the controller, and wherein the at least one microprocessor of the controller is configured to at least partially cancel noise corresponding to signals received from the error microphone by outputting the control signal to the at least one loudspeaker.

12. A motor vehicle comprising:
an internal combustion engine having an engine control unit;
an intake system in fluid communication with the internal combustion engine;
an exhaust system in fluid communication with the internal combustion engine;
an automobile battery; and
a system for influencing at least one of exhaust gas noises and intake noises and engine noises of a vehicle, the system comprising:
a controller; and
at least one loudspeaker connected to the controller for receiving control signals, with the at least one loudspeaker configured for generating a noise in response to a control signal received from the controller, wherein the controller comprises:
at least one microprocessor configured for generating a digital control signal, with the digital control signal being adapted to at least one of cancel noise inside an intake system of the vehicle at least partially, and cancel noise inside an exhaust system of the vehicle at least partially, and generate an engine noise inside an engine compartment;
at least one digital-to-analog converter connected to the at least one microprocessor and being adapted to convert the digital control signal output from the at least one microprocessor into an analog control signal;
at least one amplifier connected to the at least one digital-to-analog converter and being adapted to amplify the analog control signal; and
a step-up converter connected to the automobile battery of the vehicle and being adapted to up-convert a battery voltage supplied by the automobile battery to a higher, constant voltage value, and to output the up-converted battery voltage as supply voltage to the at least one amplifier.

13. The motor vehicle according to claim 12, wherein:
the system further comprises a sound generator, the loudspeaker being configured for generating the noise inside the sound generator, wherein the sound generator is in fluid communication with at least one of the intake system and the exhaust system; and
the controller of the system is connected to the engine control unit of the internal combustion engine of the vehicle.

14. The motor vehicle according to claim 13, wherein:
the controller comprises an error microphone disposed at a position of the intake system located with respect to the flow of the drawn in air in a region of the fluid connection between the sound generator and the intake system and being connected to the intake system; and
the controller is connected to the error microphone.

15. The motor vehicle according to claim 13, wherein:
the controller comprises an error microphone disposed at a position of the exhaust system located with respect to the flow of the exhaust gases in a region of the fluid connection between the sound generator and the exhaust system and being connected to the exhaust system; and
the controller is connected to the error microphone.

16. The motor vehicle according to claim 12, wherein a filter comprising a voltage smoothing circuit, is disposed between the automobile battery and the step-up converter.

17. The motor vehicle according to claim 12, wherein:
the at least one amplifier is a class D amplifier; and
a LC low pass is disposed between the at least one amplifier and the at least one loudspeaker.

18. The motor vehicle according to claim 14, wherein:
the controller comprises an error microphone disposed at a position of the exhaust system located with respect to the flow of the exhaust gases in a region of the fluid connection between the sound generator and the exhaust system and being connected to the exhaust system; and
the controller is connected to the error microphone.

19. The motor vehicle according to claim 12, wherein:
the step-up converter is configured to up-convert the battery voltage supplied from the automobile battery to a constant value that can be preset to at least one of 32 V, 36 V, 42 V and 48 V, as the supply voltage to the at least one amplifier;
a filter with a voltage smoothing circuit, is disposed between the automobile battery and the step-up converter;
the at least one loudspeaker has an input impedance of between 352 and 451;
the at least one amplifier is a class D amplifier; and
a LC low pass is disposed between the at least one amplifier and the at least one loudspeaker.

20. The motor vehicle according to claim 12, wherein:
the system further comprises a sound generator, the loudspeaker being configured for generating the noise inside the sound generator, wherein the sound generator is in fluid communication with the engine compartment or disposed within the engine compartment; and
the controller of the anti-noise system is connected to the engine control unit of the driving engine of the vehicle.
